(19) United States
(12) Patent Application Publication
(10) Pub. No.: US 2023/0008134 A1
(43) Pub. Date: Jan. 12, 2023

(54) ROBOTIC WORK TOOL SYSTEM AND METHOD FOR DEFINING A WORKING AREA PERIMETER

(71) Applicant: HUSQVARNA AB, Huskvarna (SE)

(72) Inventors: Jim Olofsson, JÖNKÖPING (SE); Amir Mustedanagic, Huskvarna (SE)

(21) Appl. No.: 17/782,774

(22) PCT Filed: Oct. 15, 2020
(86) PCT No.: PCT/EP2020/078980

§ 371 Date: Jun. 6, 2022

(30) Foreign Application Priority Data
Dec. 6, 2019 (SE) 1951412-4

(51) Int. Cl. A01D 34/00; G05D 1/02

(52) U.S. Cl. CPC A01D 34/008; G05D 1/0259

(57) ABSTRACT

A robotic work tool system (200) for defining a working area perimeter (105). The robotic work tool system (200) comprises a robotic work tool (100) and a controller (210). The robotic work tool (100) comprises a position unit (175) and a sensor unit (170). The controller (210) is configured to receive, from the sensor unit (170), edge data indicating whether the robotic work tool (100) is located next to a physical edge (430). The controller (210) is further configured to control the robotic work tool (100) to travel along the physical edge (430) while the edge data indicating that the robotic work tool (100) is located next to the physical edge (430) and to receive, from the position unit (175), position data while the robotic work tool (100) is in motion. The controller (210) is configured to determine, based on the edge data and position data, positions representing the physical edge (430) and to define, based on the determined positions, at least a portion of the working area perimeter (105).

### TECHNICAL FIELD

This disclosure relates to a robotic work tool system as well as a method for defining a working area perimeter surrounding a working area in which a robotic work tool is subsequently intended to operate.

### BACKGROUND

A robotic work tool is an autonomous robot apparatus that is used to perform certain tasks, for example for cutting lawn grass. A robotic work tool may be assigned an area, hereinafter referred to as a working area, in which the robotic work tool is intended to operate. This working area may be defined by the perimeter enclosing the working area. This perimeter may include the borders, or boundaries, which the robotic work tool is not intended to cross.

There exist different ways of setting these boundaries for the robotic work tool. Traditionally, the boundaries, or the perimeter, for the working area have been set manually by a user or operator. The user manually sets up a boundary wire around the area, or lawn, which defines the area to be mowed. A control signal may then be transmitted through the boundary wire. The control signal may preferably comprise a number of periodic current pulses. As is known in the art, the current pulses will typically generate a magnetic field, which may be sensed by the robotic work tool. The robotic work tool may accordingly use these signals from the wire to determine whether the robotic work tool is close to, or is crossing a boundary wire. As the robotic work tool crosses the boundary wire, the direction of the magnetic field will change. The robotic work tool will be able to determine that the boundary wire has been crossed and take appropriate action to return into the working area. However, these boundary wires are typically very time consuming to put into place, as the user has to perform this procedure manually. Once the boundary wires are put into place, the user typically rather not moves them.

In view of the above, another way to set the boundaries for a robotic work tool has been proposed, namely a way that does not use physical boundary wires. The robotic work tool may use a satellite navigation device and/or a deduced reckoning navigation sensor to remain within a working area by comparing the successive determined positions of the robotic work tool against a set of geographical coordinates defining the boundary of the working area. This set of boundary defining positions may be stored in a memory, and/or included in a digital (virtual) map of the working area.

The above-described non-physical boundaries for a working area may reduce the time necessary for installation and setting the boundaries for the working area. The non-physical boundaries may be smooth to install. Generally, they may be set by driving the robotic work tool one lap around the working area in order to establish the set of geographical coordinates defining the boundary of the working area in which the robotic work tool is intended to operate. As the boundaries are easy to set, they are also easy to move if the working area, for example, changes. Accordingly, non-physical boundaries provide a flexible solution for defining a working area.

### SUMMARY

The inventors of the various embodiments of the present disclosure have realized that even if using non-physical boundaries have many advantages, there exist drawbacks with the installation of the above proposed wireless working area perimeter that has not yet been addressed. The inventors have realized that even if installing non-physical boundaries may be smooth, the process requires constant attention of a user and thus, the installation process could be even smoother. Furthermore, when using non-physical boundaries, there is always a risk of the robotic work tool losing its position. The precision of the position of the robotic work tool may be strongly affected by nearby physical objects such as houses, trees and metal fences, which typically are located close to the boundary of working area. Thus, there is also a need for a solution that allows the working area to be defined in a more reliable way, which may ensure that the robotic work tool does not leave the defined working area when operating within this area.

In view of the above, it is therefore a general object of the aspects and embodiments described throughout this disclosure to provide a solution for defining a reliable working area perimeter in a flexible way.

This general object has been addressed by the appended independent claims. Advantageous embodiments are defined in the appended dependent claims.

According to a first aspect, there is provided a robotic work tool system for defining a working area perimeter surrounding a working area in which a robotic work tool is subsequently intended to operate.

In one exemplary embodiment, the robotic work tool system comprises a robotic work tool. The robotic work tool comprises at least one position unit and at least one sensor unit. The at least one position unit is configured to receive position data. The at least one sensor unit is configured to obtain edge data. The robotic work tool system further comprises at least one controller for controlling operation of the robotic work tool. The at least one controller is configured to receive, from the at least one sensor unit, edge data indicating whether the robotic work tool is located next to a physical edge. The at least one controller is further configured to control the robotic work tool to travel along the physical edge while the edge data indicating that the robotic work tool is located next to the physical edge and to receive from the at least one position unit, position data while the robotic work tool is in motion. The at least one controller is further configured to determine, based on the received edge data and position data, positions representing the physical edge and to define, based on the positions representing the physical edge, at least a first portion of the working area perimeter. According to embodiments, the controller may be configured to control the robotic work tool to automatically follow the physical edge, and/or autonomously propel itself along the physical edge.

In some embodiments, the at least one sensor unit is configured to obtain edge data, wherein the edge data represents a physical edge. The edge data may be obtained by detecting a terrain boundary. A physical edge may be identified based on e.g. a detection of contours, and/or based on differences in structure and/or texture between different areas.

In some embodiments, the at least one controller is configured to output a notification when the received edge data indicates that the robotic work tool is not located next to a physical edge.

In some embodiments, the at least one controller may be configured to control the robotic work tool to continue forward when the received edge data indicates that the robotic work tool is no longer located next to a physical edge. In some embodiments, the at least one controller is configured to control the robotic work tool to continue forward, during a period of time, until the received edge data indicating that the robotic work tool is located next to the physical edge. The at least one controller may be configured to define a second portion of the working area perimeter based on the position data received during the time period.

In some embodiments, the at least one controller is configured to connect a plurality of defined portions of the working area perimeter into one portion representing the working area perimeter.

In some embodiments, the at least one sensor unit is configured to obtain edge data associated with a distance and/or an angle between the at least one sensor unit and the physical edge. In particular, the at least one sensor unit may be a depth sensor configured to obtain depth data. Such depth data may, according to embodiments, represent a three-dimensional surface. The at least one sensor unit may comprise of at least one from the group: a single camera, a stereo camera, a Time-Of-Flight (TOF), camera, a radar sensor, a lidar sensor and an ultrasonic sensor.

In some embodiments, the at least one controller is configured to identify, based on data from the at least one sensor unit, an obstacle in the terrain and, based on the position of the obstacle, determine whether the obstacle defines a physical edge for defining said at least a first portion of a working area perimeter. For example, a tree positioned substantially along the tangent of an already detected terrain edge segment may be assumed, or suggested to a user, to form part of the working area perimeter. Similarly, e.g. a row of aligned trees may be identified as a physical edge for defining said at least a first portion of the working area perimeter.

In some embodiments, the at least one controller is configured to determine, based on data from the at least one sensor unit, whether the physical edge forming the basis of the working area perimeter defines an unpassable physical barrier, i.e. a barrier which the robotic work tool will be unable to pass. By way of example, a robotic lawnmower is typically able to cross a physical edge between a paved area and a grass area, whereas it is unable to pass a barrier defined by a building, a dense hedge, a low fence, etc. The determination whether the physical edge defines an unpassable physical barrier may be made based on a detected geometry of the detected edge, which geometry may be determined in one, two, or three dimensions. For example, detected objects having a height exceeding a limit height above the ground may be tagged as defining an unpassable physical barrier.

In some embodiments, the at least one controller is configured to identify, based on data from the at least one sensor unit, a portion of the working area perimeter which is not associated with an unpassable physical barrier, and indicate said portion of the working area as unsafe. The indication as unsafe may also be based on the additional condition that a GNSS signal is unreliable at the identified working area perimeter which is not associated with an unpassable physical barrier. The indication as unsafe may be used internally within the robotic work tool for preventing operation of the robotic work tool in an unsafe working area, and/or for indicating to a user via a user interface that the installation may be unsafe.

In some embodiments, the at least one position unit is configured to use a Global Navigation Satellite System (GNSS). The at least one position unit may be configured to use Real-Time Kinematic (RTK) positioning for enhancing the accuracy of GNSS positioning.

In some embodiments, the at least one position unit is configured to use dead reckoning. By way of example, dead reckoning may supplement GNSS based positioning whenever GNSS reception is unreliable.

In some embodiments, the at least one controller is configured to control the robotic work tool to travel along the physical edge with a distance from the physical edge.

In some embodiments, the robotic work tool system further comprises a user interface configured to display the defined working area perimeter. The user interface is configured to receive user input from a user during the user's operation and interaction with said user interface. The at least one controller is configured to adjust the defined working area perimeter based on received user input.

In some embodiments, the at least one controller is configured to start defining a working area perimeter in response to that a signal initiating an automatic installation mode is received. The at least one controller may be further configured to disable a cutting tool of the robotic work tool in response to that the automatic installation mode signal is received.

In some embodiments, the at least one controller is configured to control the robotic work tool to stop travelling when it has reached an initial position at which the working area perimeter defines a closed loop.

In some embodiments, the robotic work tool is a robotic lawn mower.

According to a second aspect, there is provided a method implemented by the robotic work tool system according to the first aspect.

In one exemplary implementation, the method is performed by a robotic work tool system for defining a working area perimeter surrounding a working area in which a robotic work tool is subsequently intended to operate. The method comprises receiving, from at least one sensor unit of the robotic work tool, edge data indicating whether the robotic work tool is located next to a physical edge and controlling the robotic work tool to travel along the physical edge while the edge data indicating that the robotic work tool is located next to the physical edge. The method further comprises receiving from at least one position unit of the robotic work tool, position data while the robotic work tool is in motion and determining, based on the received edge data and position data, positions representing the physical edge. The method thereafter comprises defining at least a first portion of the working area perimeter based on the positions representing the physical edge.

In some embodiments, the method further comprises outputting a notification when the received edge data indicates that the robotic work tool is not located next to a physical edge.

In some embodiments, the method further comprises controlling the robotic work tool to continue forward, during a period of time, until the received edge data indicating that the robotic work tool is located next to the physical edge. The method may further comprise defining a second portion of the working area perimeter based on the position data received during the time period.

In some embodiments, the method further comprises connecting a plurality of defined portions of the working area perimeter into one portion representing the working area perimeter.

In some embodiments, the method further comprises controlling the robotic work tool to travel along the physical edge with a distance from the physical edge.

In some embodiments, the method further comprises starting defining a working area perimeter in response to that a signal initiating an automatic installation mode is received. In some embodiments, the method may further comprise disabling a cutting tool of the robotic work tool in response to that the automatic installation mode signal is received. The method may further comprise controlling the robotic work tool to stop travelling when it has reached an initial position at which the working area perimeter defines a closed loop.

According to a third aspect, there is provided a robotic work tool system configured to define a working area in which a robotic work tool is subsequently intended to operate. The robotic work tool system comprises the robotic work tool. The robotic work tool comprises at least one position unit configured to receive position data and at least one controller for controlling operation of the robotic work tool. The at least one controller is configured to control the robotic work tool to travel and to receive position data from the at least one position unit while the robotic work tool is in motion. The at least one controller is further configured to define, based on the received position data, at least a portion of the working area perimeter and to verify that the defined working area perimeter is a closed unbroken loop.

Some of the above embodiments eliminate or at least reduce the problems discussed above. A robotic work tool system and method are provided which may define a reliable working area perimeter in a flexible way. The working area perimeter may be defined automatically and may thus be easy to both define and to re-define. Furthermore, the proposed robotic work tool system and method make it possible to lay the virtual boundary close to a real boundary of the working area perimeter and thus make it possible for the robotic work tool to operate in the overall intended working area.

Furthermore, by also notifying when the robotic work tool is not located next to a physical edge, a user of the robotic work tool may be notified when the robotic work tool has reach areas where the defining of the working area perimeter might need some extra attention. When the robotic work tool is not located next to a physical edge, the position of the defined working area perimeter relies only on the received position data. Thus, it makes it possible to take a conscious decision whether extra attention to that portion of the working area perimeter is needed or if that is not needed.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

These and other aspects, features and advantages will be apparent and elucidated from the following description of various embodiments, reference being made to the accompanying drawings, in which:

FIG. 1 shows a schematic overview of a robotic work tool in a working area;

FIG. 2 illustrates a schematic view of a robotic work tool system according to one embodiment;

FIG. 3 shows a schematic overview of a robotic work tool;

FIG. 4 shows a robotic work tool driving next to a physical edge;

FIG. 5 illustrates an example embodiment of a robotic work tool driven to define at least a portion of working area perimeter;

FIG. 6 illustrates an example embodiment of a defined portion of a working area perimeter;

FIG. 7 shows an example of manipulation of a defined working area perimeter by interaction with a user interface;

FIG. 8 shows a flowchart of an example method performed by a robotic work tool system; and

FIG. 9 shows a schematic view of a computer-readable medium according to the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

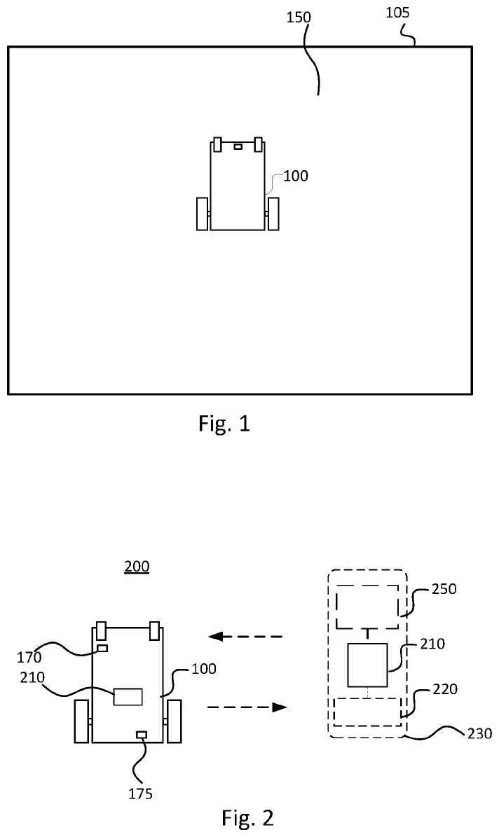

In one of its aspects, the disclosure presented herein concerns a robotic work tool system for defining a working area perimeter surrounding a working area in which a robotic work tool subsequently is intended to operate. FIG. 1 illustrates a schematic overview of a robotic work tool 100 in such a working area 150. As will be appreciated, the schematic view is not to scale. If the working area 150 is a lawn and the robotic work tool 100 is a robotic lawn mower, the working area 150 is the area to be mowed by the robotic work tool 100. As seen in FIG. 1, the working area 150 is surrounded by a working area perimeter 105, which sets the boundaries for the working area 150, i.e. defines the boundaries for the working area 150. The robotic work tool 100 is intended to operate within the working area 150 and remain within this area due to the defined working area perimeter 105. By defining the working area perimeter 105, the robotic work tool 100 will not cross the perimeter and only operate within the enclosed area, i.e. the working area 150.

With reference to FIG. 2, a first embodiment according to the first aspect will now be described. FIG. 2 shows a schematic view of a robotic work tool system 200, the robotic work tool system 200 comprises a robotic work tool 100 and at least one controller 210. The at least one controller 210 may be, for example, a controller 210 located in the robotic work tool 100. In such embodiments, the robotic work tool 100 may correspond to the robotic work tool system 200. According to another example, the at least one controller 210 may be located in a device 230 that is separate from the robotic work tool 100. When the at least one controller 210 is located in another device 230 than in the robotic work tool 100, the separate device 230 is communicatively coupled to the robotic work tool 100. They may be communicatively coupled to each other by a wireless communication interface. Additionally, or alternatively, the wireless communication interface may be used to communicate with other devices, such as servers, personal computers or smartphones, charging stations, remote controls, other robotic work tools or any remote device, which comprises a wireless communication interface and a controller. Examples of such wireless communication are Bluetooth®, Global System Mobile (GSM) and Long Term Evolution (LTE), 5G or New Radio (NR), to name a few.

The at least one controller 210 of the robotic work tool system 200 is configured to control the operation of the at least one robotic work tool 100. In one embodiment, the at least one controller 210 is embodied as software, e.g. remotely in a cloud-based solution. In another embodiment, the at least one controller 210 may be embodied as a hardware controller. The at least one controller 210 may be implemented using any suitable, publicly available processor or Programmable Logic Circuit (PLC). The at least one controller 210 may be implemented using instructions that enable hardware functionality, for example, by using executable computer program instructions in a general-purpose or special-purpose processor that may be stored on a computer readable storage medium (disk, memory etc.) to be executed by such a processor. The controller 210 may be configured to read instructions from a memory 120, 220 and execute these instructions to control the operation of the robotic work tool 100 including, but not being limited to, the propulsion of the robotic work tool 100. The memory 120, 220 may be implemented using any commonly known technology for computer-readable memories such as ROM, RAM, SRAM, DRAM, FLASH, DDR, SDRAM or some other memory technology.

The robotic work tool 100 may be realised in many different ways. While the present disclosure will mainly be described in general terms of an autonomous robot designed for mowing a lawn, it should be understood that the robotic work tool 100 described herein may be implemented into any type of autonomous machine that may perform a desired activity within a desired working area. Examples of such types of autonomous machines include, without limitation, cleaning robotic work tools, polishing work tools, repair work tools, surface-processing work tools (for indoors and/or outdoors), and/or demolition work tool or the like.

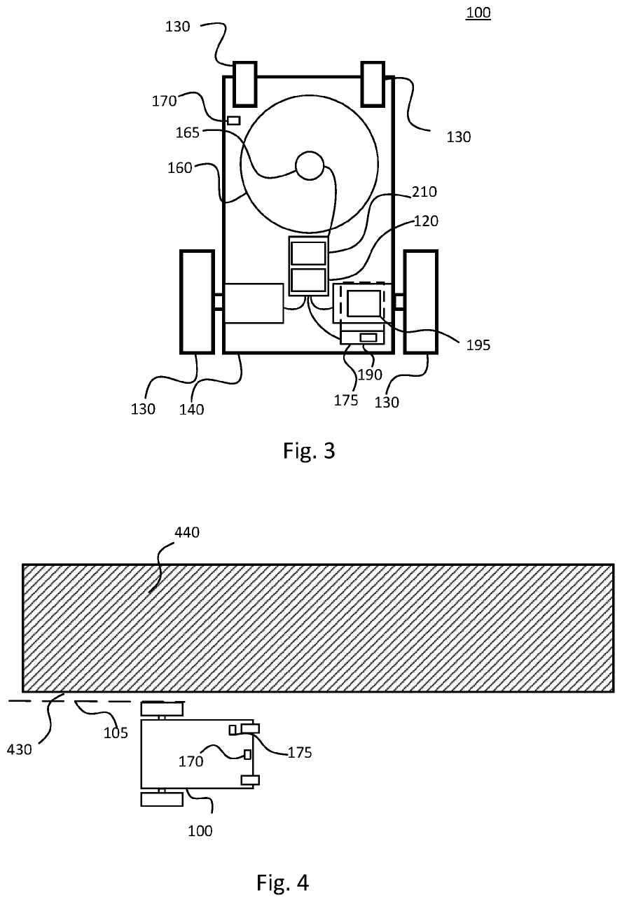

FIG. 3 shows a schematic overview of one exemplary robotic work tool 100, which may be exemplified as a robotic lawnmower. As will be appreciated, the schematic view is not to scale. FIG. 3 shows a robotic work tool 100 having a body 140 and a plurality of wheels 130. However, it may be appreciated that the robotic work tool 100 is not limited to have one single integral body. Alternatively, the robotic work tool 100 may have a separate front and rear carriages.

The robotic work tool 100 comprises at least one sensor unit 170. The at least one sensor unit 170 is configured to obtain edge data. The edge data may be data representing a physical edge, for example a terrain boundary. The terrain boundary may be a boundary of a working area 150. House walls, fences, bushes and hedges may exemplify terrain boundaries. The at least one sensor unit 170 is preferably located in a side direction of the robotic work tool 100, which is also illustrated in FIG. 3. The at least one sensor unit 170 may be configured to obtain edge data associated with a distance or an angle between the at least one sensor unit 170 and a physical edge. Alternatively, the at least one sensor unit 170 may be configured to obtain edge data associated with a distance and an angle between the at least one sensor unit 170 and a physical edge. The at least one sensor unit 170 may additionally provide some kind of structure or geometry of the physical edge that the edge data relates to. Thus, the received edge data may reflect if there is a physical edge 430, at which distance from the robotic work tool 100 it is located and potentially also the structure, or the geometry, of the physical edge. The at least one sensor unit 170 may comprise of at least one from the group comprising a single camera, a stereo camera, a Time-Of-Flight (TOF) camera, a radar sensor, a lidar sensor and an ultrasonic sensor.

According to some embodiments, the at least one sensor unit 170 may be permanently mounted to the robotic work tool 100. According to other embodiments, the at least one sensor unit 170 may be detachably attached to the robotic work tool 100. Thus, the at least one sensor unit 170 may be temporary attached to the robotic work tool 100. In accordance with such embodiments, the at least one sensor unit 170 may be attached to the robotic work tool 100 when defining the working area perimeter 105, but may be detached from the robotic work tool 100 when the robotic work tool 100 operates within the working area 150.

The robotic work tool 100 further comprises at least one position unit 175. The at least one position unit 175 is configured to receive position data. The position unit 175 may comprises a satellite signal receiver 190, which may be a Global Navigation Satellite System (GNSS) satellite signal receiver. An example of such a system is Global Positioning System (GPS). The at least one position unit 175 may be configured to use, for example, Real-Time Kinematic, RTK, positioning. In advantageous embodiments, the at least one position unit 175 may use RTK-GNSS positioning. A RTK-GNSS system is based on satellite communication. The at least one position unit 175 may be connected to the controller 210 for enabling the controller 210 to determine current positions for the robotic work tool 100.

In some embodiments, the at least one position unit 175 may further comprise a deduced reckoning navigation sensor 195 for providing signals for deduced reckoning navigation, also referred to as dead reckoning. Examples of such deduced reckoning navigation sensors 195 are odometers, inertial measurement units (IMUs) and compasses. These may comprise, for example, wheel tick counters, accelerometers and gyroscopes. Additionally, visual odometry may be used to further strengthen the dead reckoning accuracy. Thus, in some embodiments, the at least one controller 210 may be configured to use dead reckoning to extrapolate the position data if the quality, or the strength, of the position data received from the satellite signal receiver 190 goes below an acceptable level. The dead reckoning may then be based on the last known position received from the satellite signal receiver 190.

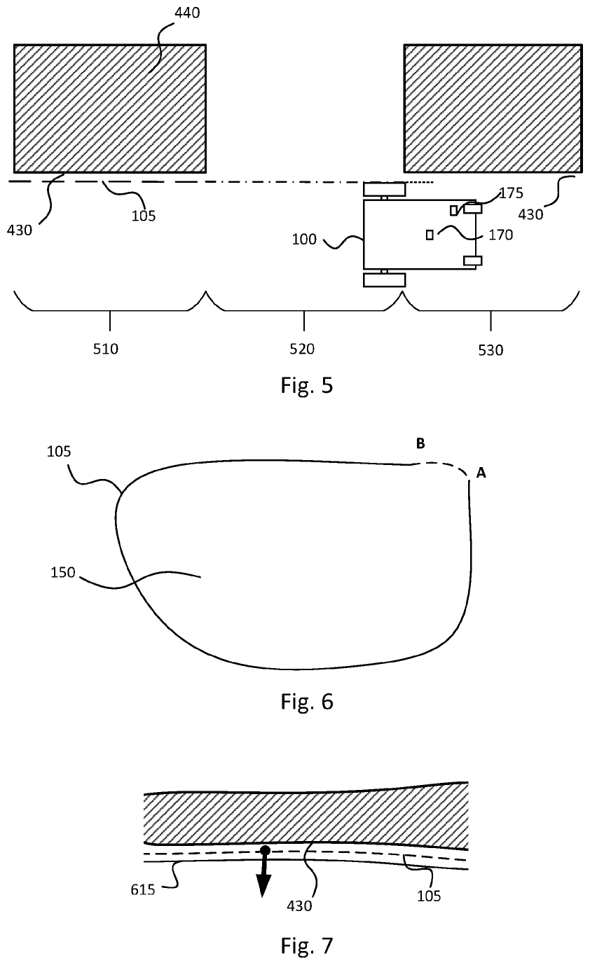

According to the present disclosure, the at least one controller 210 is configured to receive, from the at least one sensor unit 170, edge data indicating whether the robotic work tool 100 is located next to a physical edge. This is illustrated in FIG. 4. In FIG. 4, the robotic work tool 100 is located next to a physical edge 430. The physical edge 430 may be, for example, a terrain boundary, which may be an edge of an object 440 located at the perimeter of the working area. Examples of such objects 440 are houses, hedges, bushes and/or fences. Thus, based on the edge data received from the at least one sensor unit 170 it may be detected whether the robotic work tool 100 is located next to a physical edge 430 or not. The at least one controller 210 is configured to control the robotic work tool 100 to travel along the physical edge 430 while the edge data indicating that the robotic work tool 100 is located next to the physical edge 430. Thus, as long as the received edge data indicates that the robotic work tool 100 is located next to a physical edge 430, the robotic work tool 100 is controlled to automatically move forward and navigate to follow the physical edge 430. As previously described, if the edge data reflects that there is a physical edge 430 located next to the robotic work tool 100, the received edge data also represents a relative position of the robotic work tool 100, i.e. the position of the robotic work tool 100 relative the physical edge 430. While the robotic work tool 100 is in motion, the at least one controller 210 is further configured to receive, from the at least one position unit 175, position data. Thus, the at least one controller 210 continuously receives position data relating to the position of the robotic work tool 100 while the robotic work tool 100 is caused to move.

The at least one controller 210 is thereafter configured to determine, based on the received edge data and the received position data, positions representing the physical edge 430. As the received position data represents the position of the robotic work tool 100 and the received edge data represents the relative position of the robotic work tool 100 to the physical edge 430, positions representing the physical edge 430 are possible to determine. Based on the positions representing the physical edge 430, the at least one controller 210 is configured to define at least a first portion of the working area perimeter 105. The at least first portion of the working area perimeter 105 may be defined to be located at, or some offset away from, the physical edge 430. Thus, a virtual boundary represented by the at least first portion of the working area perimeter 105 may be defined at, or some offset away from, the physical edge 430.

By introducing the above proposed robotic work tool system 200, the previously described disadvantages are eliminated or at least reduced. With the provided robotic work tool system 200, it is possible to define, at least portions of, a working area perimeter 105 automatically. The robotic work tool 100 will define the working area perimeter 105 without involvement of a user. The user does not have to, manually, drive the robotic work tool 100 around the working area 150 to define the working area perimeter 105. As the process of defining the working area perimeter 105 is relatively easy to perform, the provided solution is flexible and the working area perimeter 105 also easy to re-define. Furthermore, as the robotic work tool system 200 may use both position data and edge data to define at least a first portion of the working area perimeter 105, the working area perimeter 105 is defined with a high reliability as the robotic work tool system 200 does not solely rely on position data, which may be incorrect or incomplete due to disturbing objects located close to the working area 150. In addition to this, the robotic work tool system 200 may further define a working area perimeter 105, which is defined at, or close to, the real boundary of the working area 150 making it possible for the robotic work tool 100 to operate within the complete working area 150.

In some embodiments, the at least one controller 210 may be configured to control the robotic work tool 100 to travel along the physical edge 430 with a distance from the physical edge 430. This may be beneficial in order to minimize the risk of the at least one position unit 175 being in a shadow caused by the physical edge 430. If the robotic work tool 100 travels too close to the physical edge 430, the position data received from the at least one position unit 175 may be compromised. In some embodiments, the robotic work tool 100 may be caused to travel several meters from the physical edge 430, in other embodiments, the robotic work tool 100 may be caused to travel some centimetres away from the physical edge 430. As the edge data represents a relative position of the robotic work tool 100 to the physical edge 430, the size of the distance between the at least one sensor unit 175 and the physical edge is not an issue and may be of any suitable size.

The process of defining a working area perimeter 105 may be initiated by a signal. The at least one controller 210 may be configured to start defining a working area perimeter 105 in response to that a signal initiating an automatic installation mode is received. Such a signal may be initiated, for example, by the user. According to one example embodiment, the user may press a button to initiate such mode and to start the process of defining the working area perimeter 105. The user may initiate the automatic installation mode, for example, when the robotic work tool 100 is placed along a physical edge 430 of an area to be cut, i.e. a working area 150. Thus, the process of defining the working area perimeter 105 may not be started until a signal initiating an automatic installation mode has been received. As soon as the at least one controller 210 receives the signal initiating the automatic installation mode, the at least one controller 210 may receive edge data from the at least one sensor unit 170, wherein the edge data indicates whether the robotic work tool 100 is located next to the physical edge 430.

Additionally, the robotic work tool 100 may comprise a work tool 160, which may include a grass cutting device, such as a rotating blade 160 driven by a cutter motor 165. The cutter motor 165 may be connected to the controller 210, which enables the controller 210 to control the operation of the cutter motor 165. In such embodiments, the at least one controller 210 may be configured to, in response to that the automatic installation mode signal is received, disable the cutting tool 160. This may be advantageous as it generally is not desirable to perform any operation within the working area 150 before the working area 150 has been defined. For example, the cutting tool 160 may encounter hindrances or objects which may disturb the process of defining the working area perimeter 105. Additionally, if the robotic work tool system 200 defines a working area perimeter 105 that a user for some reason would like to change etc., it is probably desirable that no cutting operation has been performed in this unwanted working area 150.

As previously described, while the received edge data indicates that the robotic work tool 100 is located next to a physical edge 430, the at least one controller 210 is configured to control the robotic work tool 100 to travel along the physical edge 430. However, in some embodiments, the received edge data may indicate that the robotic work tool 100 is not located to a physical edge 430. In these embodiments, the at least one controller 210 may be configured to output a notification. Thus, a user of the robotic work tool system 200 may be warned about that the robotic work tool 100 is not located to a physical edge 430. For example, if the robotic work tool 100 is travelling along a physical edge 430 and the physical edge 430 suddenly ends, the user can be notified to be aware of this. In some embodiments, which will be described more in detail later, the robotic work tool system 200 may still continue to define the working area perimeter 105 while the edge data indicates that the robotic work tool 100 is not located to the physical edge 430. However, as the robotic work tool system 200 has output a notification, a user operating the robotic work tool system 200 may receive information about this and have knowledge about potential weaknesses of the defined working area perimeter 105, i.e. knowledge of which places no physical edge 430 surrounds the working area 150.

Additionally, when the received edge data indicates that the robotic work tool 100 is not located to a physical edge 430, the at least one controller 210 may be configured to stop the movement of the robotic work tool 100. Thus, the user of the robotic work tool system 200 may be forced to take a conscious decision about how to define a further portion of the working area perimeter 105. For example, the user may manually control the movement of the robotic work tool 100 and perform a “walk the dog” procedure. In such procedure the robotic work tool 100 is manually driven by the user along the boundary of the working area 150 to define the working area perimeter 105. The robotic work tool 100 may be driven manually until the complete working area perimeter 105 is defined or until the received edge data once again indicates that the robotic work tool 100 is located next to a physical edge 430. An example of this is illustrated in FIG. 5. When the robotic work tool 100 is located in section 510, the received edge data indicates that the robotic work tool 100 is located next to a physical edge 430 and the at least one controller 210 is configured to control the robotic work tool 100 to travel along the physical edge 430. When the physical edge 430 ends, the robotic work tool 100 enters section 520 and the received edge data will indicate that the robotic work tool 100 is not located next to the physical edge 430 anymore. As seen in FIG. 5, no physical edge 430 is located next to the working area 150 in section 520. The at least one controller 210 may then, at section 520, output a notification about this. Thus, the user may take a conscious decision about whether the robotic work tool system 200 should stop defining the working area perimeter 105 or if the process for defining the working area perimeter 105 should be continued. When the process is continued, one option may be that the user manually performs a “walk the dog” procedure over section 520, to define at least a second portion of the working area perimeter 105. The manual “walk the dog” procedure may be performed until the robotic work tool 100 once again is located next to a physical edge 430, which will happen when the robotic work tool 100 travels into section 530. Alternatively, the manual “walk the dog” procedure may be performed until the complete working area perimeter 105 is defined.

In some embodiments, when the received edge data indicates that the robotic work tool 100 is not located to a physical edge 430, the at least one controller 210 may be configured to control the robotic work tool 100 to continue forward, during a period of time, until the received edge data indicates that the robotic work tool 100 is located next to the physical edge 430. Thus, the at least one robotic work tool 100 will automatically continue forward and continue to receive position data. The at least one controller 210 may be configured to control the robotic work tool 100 to continue forward for e.g. 5 seconds. If the received edge data does not indicate any new physical edge 430 before this time has lapsed, the at least one controller 210 in some embodiments may be configured to stop the robotic work tool 100. However, if the received edge data indicates a new physical edge 430 before this time has lapsed, the at least one controller 210 may be configured to control the robotic work tool 100 to travel along the encountered new physical edge 430.

The above described embodiments may also be described with reference to FIG. 5, where a first object 440 with a first physical edge 430 is located at section 510. When the robotic work tool 100 has passed this section 510, the received edge data will indicate that the robotic work tool 100 is no longer located next to the physical edge 430. Then, the at least one controller 210 may be configured to control the robotic work tool 100 to continue forward during a period of time at section 520. Before the predetermined period of time has ended, the received edge data will once again indicate that the robotic work tool 100 is located next to a physical edge 430, at section 530. The at least one controller 210 may then continue to control the robotic work tool 100 to travel along the new physical edge 430 and the process for defining the working area perimeter 105 may continue.

One of the advantages with the robotic work tool 100 continuing travel forward while the received edge data indicates that the robotic work tool 100 is not located next to a physical edge 430 is that the robotic work tool 100 may be suitable for travelling along a hedge, for example a hedge of Swedish whitebeams. These hedges are generally planted with gaps between the trees. Thus, the robotic work tool system 200 may be configured to define a working area perimeter 105 despite that the physical edge 430, i.e. the Swedish whitebeam trees, may not be a continuous physical edge. Alternatively, the robotic work tool 100 may identify that the trees are arranged along a line, and may thereby identify the line of trees as a sufficiently continuous physical terrain edge.

In embodiments where the at least one controller 210 is configured to continue forward during a period of time, the at least one controller 210 may further be configured to define a second portion of the working area perimeter 105 based on the position data received during the time period. Thus, the at least one controller 210 may be configured to defined the second portion of the working area perimeter 105 based only on position data. In the described example with the Swedish whitebeams, this would mean that the working area perimeter 105 would be defined based on position data at the gaps between the trees.

In some embodiments, the at least one controller 210 may be configured to connect a plurality of defined portions of the working area perimeter 105 into one portion representing the working area perimeter 105. For example, if three portions of the working area perimeter 105 have been defined, as illustrated as distances 510, 520 and 530 in FIG. 5, the at least one controller 210 is configured to connect all these portions into one portion, such that the working area perimeter 105 may be represented by a closed loop. Thus, the provided robotic work tool system 200 may define a working area perimeter 105 that completely surrounds a working area 150 and which will prevent a robotic work tool 100 from leaving the defined working area 150.

The at least one controller 210 may be configured to, according to some embodiments, control the robotic work tool 100 to stop travelling when it has reached an initial position at which the working area perimeter 105 defines a closed loop. The initial position may be, for example, the position where the at least one controller 210 received an automatic installation mode signal. Alternatively, the initial position may be a position that differs from the position where the robotic work tool system 200 started to define the working area perimeter 105. Then, the at least one controller 210 may be configured to close the loop by connecting the portions of the working area perimeter 105 such that the working area 150 is surrounded by a closed loop. FIG. 6 illustrates an example where the robotic work tool 100 has been driven from point A to point B in order to define at least a portion of the working area perimeter 105 around the working area 150. As can be seen in FIG. 6, the robotic work tool 100 is not necessarily driven a complete lap around the working area 150, but enough to define the working area 150. In this example, the at least one controller 210 may be configured to close the loop by connecting point A with point B by interpolating the “missing” portion of the lap around the working area 105 such that a closed loop around the working area 150 is defined. This portion is marked as a dashed line between points B and A in FIG. 6. Accordingly, a “connected” working area perimeter 105, i.e. an enclosed area, may be defined regardless of whether the robotic work tool 100 is driven a complete lap around the working area 150 or not. This may also prevent problems that may arise if the robotic work tool 100 does not finish the lap around the working area exactly in the same place at the robotic work tool 100 started the lap.

In one embodiment, the robotic work tool system 200 may further comprise a user interface 250, as illustrated in FIG. 2. The user interface 250 may for example be a touch user interface. The user interface 250 is illustrated in the figure to be in an apparatus separated from the robotic work tool 100, but it may be appreciated that the user interface 250 may be located at the robotic work tool 100. The user interface 250 may be in the same apparatus as the at least one controller 210. However, in one embodiment the user interface 250 may be located in a device separate from the at least one controller 210.

The user interface 250 may be configured to display the defined working area perimeter 105 to a user/operator who is operating the user interface 250. In one embodiment, the preliminary working area perimeter 105 may be displayed in the user interface 250 associated with the received edge data. As previously described, the edge data may reflect a structure and/or a geometry of the physical edge 430 and based on this, the at least one controller may be configured to display the defined working area perimeter 105 associated with this edge data, which was obtained while the robotic work tool 100 was driven to define the working area perimeter 105. In one example embodiment, the edge data may be image data. Accordingly, the defined working area perimeter 105 may be overlaid with image data collected by the at least one sensor unit 170.

The user interface 250 may be configured to receive user input from a user during the user's operation and interaction with the user interface 250. The at least one controller 210 may be configured to adjust the defined working area perimeter 105 based on received user input. Thus, the user may manipulate the defined working area perimeter 105 by interacting with the user interface 250. An example of this is illustrated in FIG. 7.

FIG. 7 schematically illustrates an example embodiment of a view of the user interface 250. The user interface 250 may display the defined at least first portion of the working area perimeter 105 that the robotic work tool system 200 has defined. If the user for some reason would like to refine a defined working area perimeter, it may be possible to do that with the user interface 250. It may be possible to, for example, move the defined working area perimeter 105 away from the physical edge by touching and dragging the preliminary working area perimeter 105 towards a wanted adjusted working area perimeter 615.

By providing the user interface 250 as described above, a fast and simple adaptation of the defined working area perimeter 105 may be achieved. For example, if it for some reason is not desirable that the robotic work tool 100 is driven too close to a physical edge 430 when the robotic work tool 100 is operating in the working area 150, this may be achieved by adjusting the defined working area perimeter 105 to be located a bit further away from the physical edge 430.

In some embodiments, the robotic work tool system 200 may be configured to process and analyze the edge data and determine what the edge data discloses. As previously described, the edge data may represent a boundary of the working area 150. However, it might happen that an obstacle, for example a wheelbarrow, is placed at the boundary of the working area 150. Then, the robotic work tool 100, which is caused to travel along the physical edge 430, may receive edge data from the sensor unit 170 that does not represent the boundary of the working area 150. In order to determine whether the received edge data corresponds to a physical edge 430 representing a boundary of the working area 150 or an obstacle placed close to the boundary of the working area 150, the at least one controller 210 in some embodiments may be configured to classify the received edge data. By classifying the received edge data, the at least one controller 210 may be able to distinguish between objects and determine whether the edge data really represents a physical edge 430 at the boundary of the working area 150 or if the edge data solely represents an obstacle located at the boundary.

In case, the at least one controller 210 determines that there is an obstacle located at the boundary of the working area 150, there may be several possibilities of what the at least one controller 210 may be configured to do. In some embodiments, the at least one controller 210 may be configured to output a notification about the obstacle. Alternatively, or additionally, the at least one controller 210 may be configured to stop the robotic work tool 100 when it is determined that the edge data represents an obstacle. Alternatively, the robotic work tool 100 may be caused to continue travel along the obstacle and pass the obstacle until it once again reaches the physical edge 430 located at the boundary of the working area 150. In these embodiments, the at least one controller 210 may be configured to extrapolate the working area perimeter 105 by connecting the portion of the working area perimeter 105 before the obstacle was detected with a portion of the working area perimeter 105 located after the obstacle. The portion of the working area 105 located after the obstacle may be detected by the edge data once again indicating that the robotic work tool 100 is located next to a physical edge 430.

In one embodiment, the at least one controller 210 of the robotic work tool system 200 may be configured to, after that a closed loop surrounding the working area 150 has been defined, drive the robotic work tool 100 one additional lap around the working area 150 guided by the defined working area perimeter 105. The additional lap may e.g. be driven with the outer wheels 130 of the robotic work tool 100 located at the defined working area perimeter 105. Then it may be possible to view how the working area perimeter 105 has been defined. Thereby, it may be possible to verify that all areas are covered properly by the robotic work tool system 200.

In one advantageous embodiment, the robotic work tool 100 may be a robotic lawn mower.

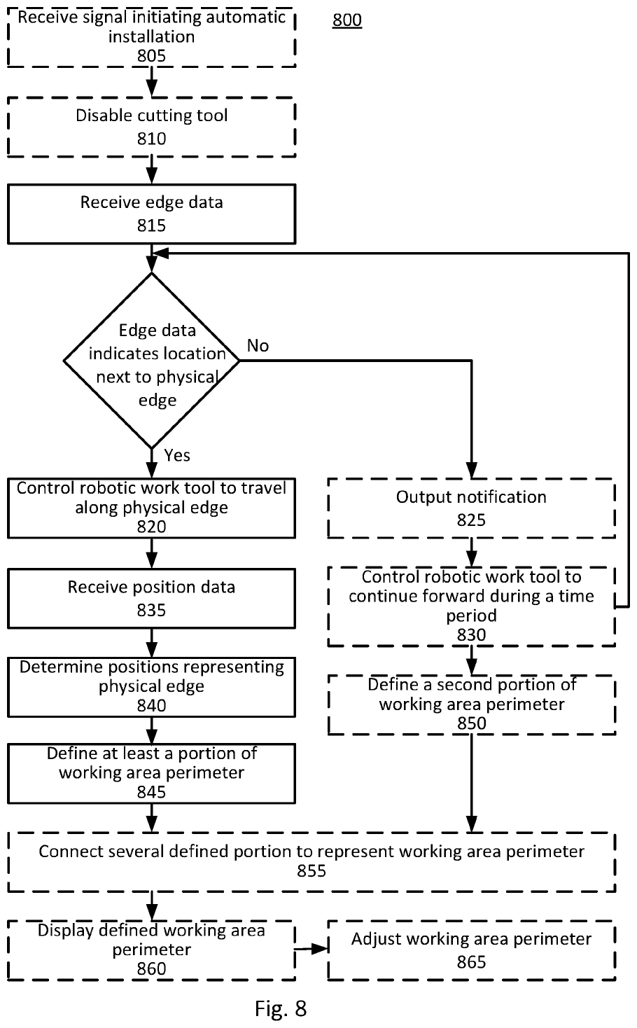

According to a second aspect, there is provided a method implemented in the robotic work tool system according to the first aspect. The method will be described with reference to FIG. 8.

In one embodiment, the method 800 may be performed by a robotic work tool system 200 for defining a working area perimeter 105 surrounding a working area 150 in which a robotic work tool 100 is subsequently intended to operate. The method 800 may comprise step 815 of receiving, from at least one sensor unit 170 of the robotic work tool 100, edge data indicating whether the robotic work tool 100 is located next to a physical edge 430. At step 820 the robotic work tool 100 is controlled to travel along the physical edge 430 while the edge data indicates that the robotic work tool 100 is located next to the physical edge 430. Thereafter, at step 835, the at least one controller 210 receives, from at least one position unit 170 of the robotic work tool 100, position data while the robotic work tool 100 is in motion. Then, at step 840, positions representing the physical edge 430 are determined based on the received edge data and position data, and at step 845, at least a first portion of the working area perimeter 105 is defined based on the positions representing the physical edge 430.

In some embodiments, the method 800 may further comprise step 825 of outputting a notification when the received edge data indicates that the robotic work tool 100 is not located next to a physical edge 430.

In some embodiments, the method 800 may further comprise step 830 of controlling the robotic work tool 100 to continue forward, during a period of time, until the received edge data indicating that the robotic work tool 100 is located next to the physical edge 430. The method 800 may further comprise step 850 of defining a second portion of the working area perimeter 105 based on the position data received during the time period.

In some embodiments, the method 800 may further comprise step 855 of connecting a plurality of defined portions of the working area perimeter 105 into one portion representing the working area perimeter 150.

In some embodiments, the method 800 may further comprise step 860 of displaying the defined working area perimeter 105 using a user interface. In some embodiments, the method 800 may further comprise step 865 of adjusting the defined working area perimeter 105 based on received user input, which is received via the user interface 250.

In some embodiments, the method 800 may further comprise controlling the robotic work tool 100 to travel along the physical edge 430 with a distance from the physical edge.

In some embodiments, the method 800 may further comprise starting defining a working area perimeter 105 in response to that a signal initiating an automatic installation mode is received. In some embodiments, the method 800 may further comprise disabling a cutting tool of the robotic work tool 100 in response to that the automatic installation mode signal is received. The method 800 may further comprise controlling the robotic work tool 100 to stop travelling when it has reached an initial position at which the working area perimeter 105 defines a closed loop.

With the proposed robotic work tool system 200 it may be verified that the entire working area 150 is within a closed, unbroken, loop comprised of a physical edge 430 and/or a virtual boundary where the position unit 175 has enough precision.

According to a third aspect, there is a robotic work tool system 200 configured to define a working area 150 in which a robotic work tool 100 is subsequently intended to operate. The robotic work tool system 200 comprises the robotic work tool 100. The robotic work tool 100 comprises at least one position unit 175 configured to receive position data and at least one controller 210 for controlling operation of the robotic work tool 100. The at least one controller 210 is configured to control the robotic work tool 100 to travel and to receive position data from the at least one position unit 175 while the robotic work tool 100 is in motion. The at least one controller 210 is further configured to define, based on the received position data, at least a portion of the working area perimeter 105 and to verify that the defined working area perimeter 105 is a closed unbroken loop.

Thus, the provided robotic work tool system 200 may verify that the defined working area perimeter 105 is a closed unbroken loop 105 and thus, that the working area 150 is completely surrounded by a working area perimeter 105.

In some embodiments, the robotic work tool system 200 may further comprise at least one sensor unit 170. The at least one sensor unit 170 may be configured to obtain edge data. The edge data may be received by the at least one controller 210 and may indicate whether the robotic work tool 100 is located next to a physical edge 430. The at least one controller 210 may in these embodiments be configured to control the robotic work tool 100 to travel along the physical edge 430 while the edge data indicates that the robotic work tool 100 is located next to the physical edge 430. The at least one controller 210 may further be configured to control the robotic work tool 100 to continue forward while the edge data indicates that the robotic work tool 100 is not located next to the physical edge 430. In these embodiments, the at least one controller 210 may be configured to define the at least a portion of the working area perimeter 105 based on at least one of the received edge data and the received position data.

In some embodiments, the robotic work tool 100 is positioned at a start position and the at least one controller 210 is configured to control the robotic work tool 100 to travel once the robotic work tool 100 is placed at the start position. The robotic work tool 100 is thereafter configured to travel along the working area 150 and once the robotic work tool 100 reaches the start position again, the at least one controller 210 may be configured to verify that the defined working area perimeter 105 is closed unbroken loop.

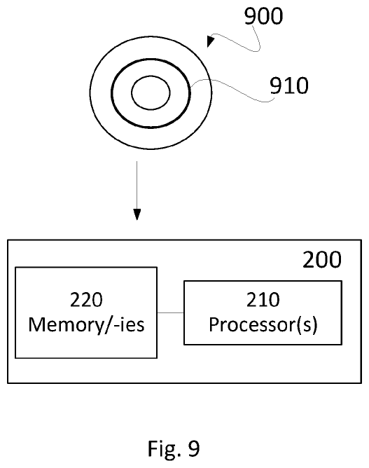

FIG. 9 shows a schematic view of a computer-readable medium as described in the above. The computer-readable medium 900 is in this embodiment a data disc 900. In one embodiment the data disc 900 is a magnetic data storage disc. The data disc 900 is configured to carry instructions 910 that when loaded into a controller, such as a processor, execute a method or procedure according to the embodiments disclosed above. The data disc 900 is arranged to be connected to or within and read by a reading device, for loading the instructions into the controller. One such example of a reading device in combination with one (or several) data disc(s) 900 is a hard drive. It should be noted that the computer-readable medium can also be other mediums such as compact discs, digital video discs, flash memories or other memory technologies commonly used. In such an embodiment the data disc 900 is one type of a tangible computer-readable medium 900.

The instructions 910 may also be downloaded to a computer data reading device, such as the controller 210 or other device capable of reading computer coded data on a computer-readable medium, by comprising the instructions 910 in a computer-readable signal which is transmitted via a wireless (or wired) interface (for example via the Internet) to the computer data reading device for loading the instructions 910 into a controller. In such an embodiment the computer-readable signal is one type of a non-tangible computer-readable medium 900.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc. Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Still further, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A robotic work tool system for defining a working area perimeter surrounding a working area in which a robotic work tool is subsequently intended to operate, the robotic work tool system comprising:
the robotic work tool, wherein the robotic work tool comprises at least one position unit configured to receive position data and at least one sensor unit configured to obtain edge data associated with a distance or an angle between the at least one sensor unit and a physical edge;
at least one controller for controlling operation of the robotic work tool, the at least one controller being configured to:
receive, from the at least one sensor unit, edge data indicating whether the robotic work tool is located next to the physical edge;
control the robotic work tool to travel along the physical edge while the edge data indicating that the robotic work tool is located next to the physical edge;
receive, from the at least one position unit, position data while the robotic work tool is in motion,
determine, based on the received edge data and position data, positions representing the physical edge; and
define, based on the positions representing the physical edge, at least a first portion of the working area perimeter.

2. The robotic work tool system according to claim 1, wherein the at least one controller is configured to output a notification when the received edge data indicates that the robotic work tool is not located next to the physical edge.

3. The robotic work tool system according to any of claim 1, wherein the at least one controller is configured to control the robotic work tool to continue forward, during a period of time, until the received edge data indicating that the robotic work tool is located next to the physical edge.

4. The robotic work tool system according to claim 3, wherein the at least one controller is configured to define a second portion of the working area perimeter based on the position data received during the period of time.

5. The robotic work tool system according to claim 1, wherein the at least one controller is configured to connect a plurality of defined portions of the working area perimeter into one portion representing the working area perimeter.

6. The robotic work tool system according to claim 1, wherein the at least one controller is configured to identify, based on data from the at least one sensor unit, an obstacle in the terrain and, based on the position of the obstacle, determine whether the obstacle defines the physical edge for defining said at least a first portion of the working area perimeter.

7. The robotic work tool system according to claim 1, wherein the at least one controller is configured to determine, based on data from the at least one sensor unit, whether the physical edge defines an unpassable physical barrier.

8. The robotic work tool system according to claim 7, wherein the at least one controller is configured to identify, based on data from the at least one sensor unit, a portion of the working area perimeter which is not associated with an unpassable physical barrier, and indicate said portion of the working area as unsafe.

9. The robotic work tool system according to claim 1, wherein the at least one sensor unit comprises of at least one from the group comprising: a single camera, a stereo camera, a Time-Of-Flight, TOF, camera, a radar sensor, a lidar sensor and an ultrasonic sensor

10. The robotic work tool system according to claim 1, wherein the at least one position unit is configured to use a Global Navigation Satellite System, GNSS, or dead reckoning.

11. The robotic work tool system according claim 10, wherein the at least one position unit is configured to use Real-Time Kinematic, RTK, positioning.

12. (canceled)

13. The robotic work tool system according to claim 1, wherein the at least one controller is configured to control the robotic work tool to travel along the physical edge with a distance from the physical edge.

14. The robotic work tool system according to claim 1, wherein the robotic work tool system further comprises a user interface configured to display the defined working area perimeter.

15. The robotic work tool system according to claim 14, wherein the user interface is configured to receive user input from a user during the user's operation and interaction with said user interface, wherein the at least one controller is configured to adjust the defined working area perimeter based on received user input.

16. The robotic work tool system according to claim 15, wherein the at least one controller is configured to start defining a working area perimeter in response to that a signal initiating an automatic installation mode is received.

17. The robotic work tool system according to claim 16, wherein the at least one controller is further configured to disable a cutting tool of the robotic work tool in response to that the automatic installation mode signal is received.

18. The robotic work tool system according to claim 17, wherein the at least one controller is configured to control the robotic work tool to stop travelling when it has reached an initial position at which the working area perimeter defines a closed loop.

19. The robotic work tool system according to claim 1, wherein the robotic work tool is a robotic lawn mower

20. A method performed by a robotic work tool system for defining a working area perimeter surrounding a working area in which a robotic work tool is subsequently intended to operate, wherein the method comprises:
receiving, from at least one sensor unit of the robotic work tool, edge data indicating whether the robotic work tool is located next to a physical edge, wherein the edge data is associated with a distance or an angle between the at least one sensor unit and the physical edge;
controlling the robotic work tool to travel along the physical edge while the edge data indicating that the robotic work tool is located next to the physical edge;
receiving, from at least one position unit of the robotic work tool, position data while the robotic work tool is in motion,
determining, based on the received edge data and position data, positions representing the physical edge; and
defining at least a first portion of the working area perimeter based on the positions representing the physical edge.

21. A robotic work tool system configured to define a working area in which a robotic work tool is subsequently intended to operate, the robotic work tool system comprising:
the robotic work tool, wherein the robotic work tool comprises at least one position unit configured to receive position data;
at least one controller for controlling operation of the robotic work tool, the at least one controller being configured to:
control the robotic work tool to travel;
receive position data from the at least one position unit while the robotic work tool is in motion;
define, based on the received position data, at least a portion of the working area perimeter;
verify, when the robotic work tool has reached the start position, that the defined working area perimeter is a closed unbroken loop.
